(19) United States
(12) Patent Application Publication
(10) Pub. No.: US 2010/0276475 A1
(43) Pub. Date: Nov. 4, 2010

(54) GAS FEED DEVICE FOR A WAVE SOLDERING OR TINNING MACHINE

(75) Inventors: Marc Leturmy, Gressey (FR); Alban Poirier, Le Chesnay (FR)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude

(21) Appl. No.: 12/812,284

(22) PCT Filed: Jan. 8, 2009
(86) PCT No.: PCT/FR09/50019

§ 371 Date: Jul. 9, 2010

(30) Foreign Application Priority Data
Jan. 10, 2008 (FR) 0850122

(51) Int. Cl. B23K 1/08; B23K 3/06; G06F 17/11

(52) U.S. Cl. 228/259; 228/37; 703/2

(57) ABSTRACT

The invention relates to a supply device for feeding a gas to a wave brazing or tinning machine, wherein said machine is capable of generating at least one soldering wave, comprising: a gas inlet channel, a set of N secondary channels immersed in the solder bath of the brazing or tinning machine, and an injection channel supplying at least one injection means for injecting the gas in the vicinity of said at least one wave, each secondary channel having its inlet end connected to the injection channel, characterized in that the number N of secondary channels is equal to or higher than 1, and in that the inner diameter d of the secondary channels and the gas flow rate Q₀ in the inlet channel are selected so that the gas flow in the secondary channels is in a turbulent mode.

The present invention relates to an inert gas feed device for a wave soldering or tinning machine.

These wave soldering or tinning machines are used especially for soldering electronic components on a support, such as an electronic circuit, or else for tinning terminations of electronic components.

The design of wave soldering machines is such that the circuits to be soldered or the parts to be tinned are brought into contact with one or more liquid solder waves obtained by pumping a bath of solder contained in a tank through a nozzle.

The parts have generally been fluxed beforehand in a zone upstream of the machine, mainly so as to deoxidize the metallic surfaces in order to make their subsequent wetting by the solder easier, the fluxing operation being followed by a preheating operation carried out both for activating the flux deposited beforehand on the circuit and for preheating the circuits and the components before they arrive in the hot soldering zone.

The geometric configuration of the nozzle determines the shape of the solder wave obtained. Wave soldering machines most usually have two waves, a “turbulent” first wave and a “laminar” second wave, this second type of wave offering a relatively extended flat upper surface.

In the absence of parts to be soldered or tinned in the machine, the liquid solder flows, in this laminar wave, at very low speed toward the upstream end of the machine. When a part arrives in contact with the laminar wave, there is a partial inversion in the flow of the solder alloy, a portion of this alloy flowing toward the downstream end of the machine.

The machines are therefore often provided with a system that may be termed a “weir”, the height of which enables the flow rate of the solder toward the downstream end to be regulated. This weir system may quite simply consist of a metal plate, or else a chute for guiding the fall of the solder back down into the surrounding bath.

It should be noted that the flow rate and the direction of flow of alloy in this laminar wave have a key influence on the quality of the soldering obtained.

It should also be noted that certain users, in order to comply with very specific characteristics of their production, considerably limit the downstream solder flow phenomenon, preferring there to be very little or even virtually no downstream overflow of the solder.

Wave soldering or tinning machines are conventionally opened to the ambient air atmosphere. Among the problems encountered by users of such machines, mention may be made of the formation of oxide layers, called dross, on the surface of the solder bath owing to its exposure to air, leading to a not insignificant loss of solder and the need to regularly clean the bath. To give an indication, a machine of average size may give rise to the formation of more than one kilogram of dross per hour of operation.

If we now consider the specific case of the laminar wave, it will be readily understood that a zero or very low downstream overflow of the solder will have a major drawback owing to the fact that the dross permanently forming on the flat surface of the wave cannot be effectively removed and will therefore be deposited on the part, significantly impairing the soldering or tinning quality obtained.

The dross effect described here in the case of the flat surface of a laminar wave of a wave soldering machine always exists in the case of the flat surface of a “dead” bath (a stagnant liquid bath).

Various technical solutions have been proposed hitherto for attempting to protect the solder bath from being oxidized by the surrounding air. These solutions may be classified in three categories:
a) the first solution category consists in providing a confined protective atmosphere, at least above the solder bath but also sometimes in the rest of the machine. At the present time, there are entirely inerted machines, designed right from the start as a sealed tunnel. Document U.S. Pat. No. 5,161,727 describes a hooding system for providing, on conventional existing machines open to the ambient air, a nitrogen cover, at least over the solder bath;
b) the second category of solutions uses the provision of non-confined protective atmospheres, via injectors located close to the solder waves, without the space lying above the waves being closed. In the second category, mention may be made of the devices reported in document WO 93/11653; and
c) the third category of solutions to the dross formation problem employs the use, on the surface of the laminar wave, of an oil film having a high covering power.

Oil-based protection systems have the conventional drawbacks of the use of oil (especially when a high-temperature source is present) which are, in particular, the presence of oil deposited on the cards, requiring often difficult and imperfect cleaning operations to be carried out and the necessity for frequent periods of maintenance of the machine owing to the build-up of oil in the solder bath, and also the emanation of oil vapor, which undoubtedly represents a nuisance for the environment, whether for the equipment or for humans.

New environmental regulations, including European Directive 2002/95/CE of Jan. 27, 2003 “relating to limiting the use of certain hazardous substances in electrical and electronic equipment” prohibit, inter alia, the use of lead in solder alloys.

Conventional lead-based solder alloys have lower melting points than replacement alloys. For example, the conventional tin-lead alloy Sn63/Pb37 has a melting point of about 183° C., whereas the SnAg3/Cu0.5 (tin/silver/copper) alloy has a melting point of about 217° C.

The use of these new alloys requires the entire wave soldering process to be modified. These new alloys impose new constraints and problems for implementing the wave soldering process, for example a higher preheating temperature and a higher soldering temperature, or even greater oxidation.

The fact that the preheating and soldering temperatures are higher poses a problem in maintaining the temperature of the circuit during its progress over the entire length of the wave soldering machine, especially between the end of the preheat and arrival on the first soldering wave, and also between the two soldering waves. At these two points in the travel of the circuit, a drop in temperature occurs, this being prejudicial to the soldering quality. This drop in temperature is increased by the injection of the inert gas in machines equipped with an inerting system located in the solder bath. Another point prejudicial to soldering relates to the outlet of the second wave, where the cooling rate is greater, resulting in a large heat shock (in the case of machines having a gas injection just downstream of this second wave).

For machines not having a system for heating the gas before injection, users are constrained to compensate for such temperature drops by overheating the solder baths. This is prejudicial to soldering and may also damage the electronic components.

The object of the present invention is to provide a solution for adapting soldering machines to the use of the new higher-melting-point alloys.

Thus, the invention relates to a gas feed device for a wave soldering or tinning machine, said machine being capable of generating at least one solder wave, comprising:
a gas inlet duct;
a set of N secondary ducts submerged in the solder bath of the soldering or tinning machine; and
an injection duct feeding at least one injection means with gas close to said at least one wave,
   each secondary duct having its inlet end connected to the inlet duct and its outlet end connected to the injection duct,
   said device being characterized in that the number N of secondary ducts is equal to or greater than 1 and in that the inside diameter d of the secondary ducts and the gas flow rate Q₀ in the inlet duct are chosen such that the flow of the gas inside the secondary ducts is in a turbulent state.

Advantageously and surprisingly, establishing a turbulent state in the secondary duct or ducts enables there to be better heat exchange between the gas and the solder bath. As a result, the length and number of secondary ducts are advantageously reduced.

A device according to the invention may furthermore include one or more of the optional features below, these being considered individually or in any possible combination:
the number N of secondary ducts, the gas flow rate Q₀ in the inlet duct in Nm³·s⁻¹ (“normal” m³ at 0° C. and 1013 mbar) and the inside diameter d in meters of the secondary ducts satisfy the following relationship (called the “Reynolds” relationship at the secondary duct outlet):

(4ρ₀Q₀)/(μₛπNd)≧2500,

and preferably (4ρ₀Q₀)/(μₛπNd)≧4000,

where ρ₀ is the density of the gas in kg·m⁻³ (under “normal” conditions at 0° C. and 1013 mbar) and μₛ is the dynamic viscosity of the gas in Pa·s at the outlet of the submerged duct;
the device satisfies the “speed limit” relationship:

Q₀≦(ρₛπd²N170)/(4ρ₀),

and preferably Q₀≦(ρₛπd²N200)/(4ρ₀),

in which ρₛ is the density of the gas in kg·m⁻³ at the submerged duct outlet;
the device satisfies the following “length” relationship (“maximum length” relationship): L/d≦275, where L is the length in meters of one of the secondary ducts;
the device satisfies the following “length” relationship (“minimum length” relationship): L/d≧100, where L is the length in meters of one of the secondary ducts;
the secondary ducts have an inside diameter of 10 mm or less; and
the gas flow rate Q₀ in the inlet duct is less than or equal to 15 Nm³·h⁻¹, preferably less than or equal to 10 Nm³·h⁻¹1, and/or greater than or equal to 1 Nm³·h⁻¹.

As will be clearly apparent to those skilled in the art, the length adopted for the submerged ducts will be one of the parameters having an influence on the temperature of the gas at the outlet of the submerged ducts and on the relatively large difference between the bath temperature and this outlet temperature.

As indicated above, it will be advantageous to adopt a ratio L/d≧100, and preferably L/d≦275, knowing of course that there is no point in increasing the submerged length unduly (no further heating of the gas takes place beyond a certain submerged length).

The invention also relates to a wave soldering or tinning machine comprising a gas feed device according to the invention.

The invention also relates to a method of designing a gas feed device according to the invention, comprising the following successive steps:
the estimation of the flow rate Q₀ in Nm³·s⁻¹ necessary for feeding gas to the inlet duct;
the determination of the pair or pairs (N,d) enabling a turbulent flow in the secondary ducts and for meeting said “speed limit” relationship;
the determination, for each pair (N,d), of the length L of the N secondary ducts enabling said length relationships (100≦L/d, and preferably L/d≦275) to be satisfied; and
the choice of a triplet (N,d,L) as a function of the geometry of the wave soldering or tinning machine on which the gas feed device is intended to be installed.

It should be noted that the flow rate Q₀ may be estimated simply by experience (because of equivalent systems already produced, or else by specific experiments on the machine in question) depending on the technical objective sought.

For example, to achieve a residual oxygen content in the bath below a limiting content, it is possible to determine the flow rate without the reheating system according to the invention, while keeping in mind the fact that the action of heating the gas in the submerged ducts will cause a volume expansion, and therefore a lower flow rate that takes into account the temperature at the outlet of the system may therefore be estimated.

In other words, the flow rate will be determined according to the objective sought: if the objective of the user is above all to minimize the consumption of gas, then he will strive to take the volume expansion into account; if the objective is above all a thermal objective (to maintain the temperature of the card between the waves, to reduce the cooling rate, etc.), then he may ignore the volume expansion.

The invention also relates to a wave soldering or tinning process, during which a part to be soldered or tinned is brought into contact with at least one liquid solder wave in which a gas is directed onto at least one portion of said at least one wave by means of a gas injection means, and in which the gas injection means is fed with gas by a feed device according to the invention.

The invention will be better understood on reading the following description, given solely by way of example and with reference to the appended drawings in which:

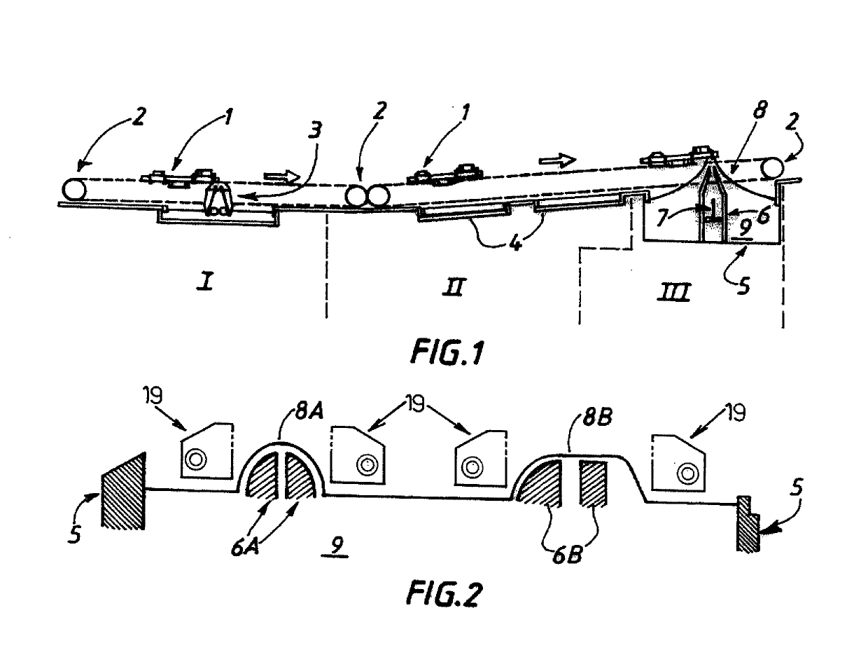

FIG. 1 is a schematic representation of a conventional wave soldering machine structure;

FIG. 2 is a schematic partial cross section through a structure having two waves, a turbulent wave and a laminar wave, indicating certain positions of the gas injection means among the many conceivable options;

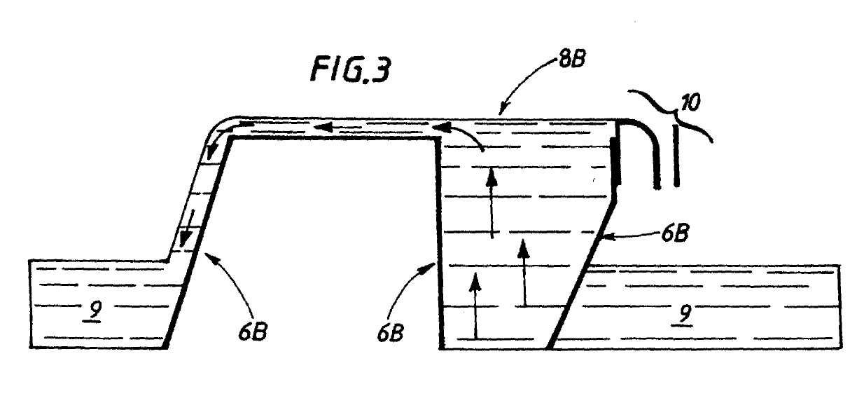

FIG. 3 is a schematic representation of a laminar wave in the situation awaiting parts (the solder flowing toward the upstream end);

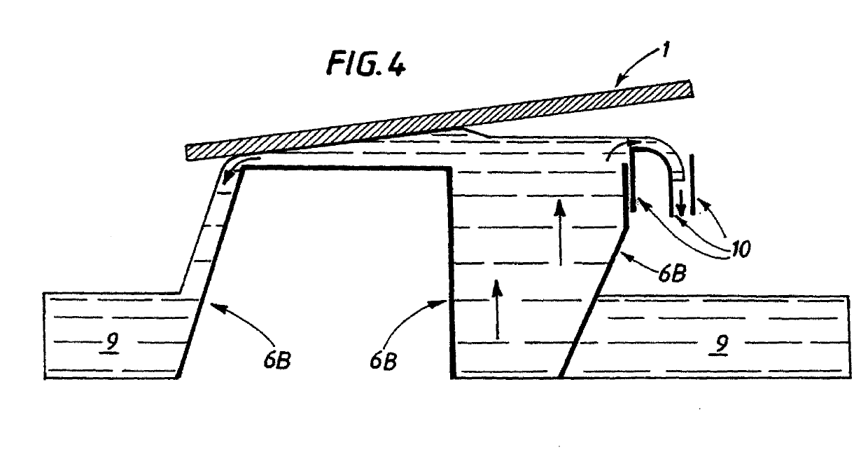

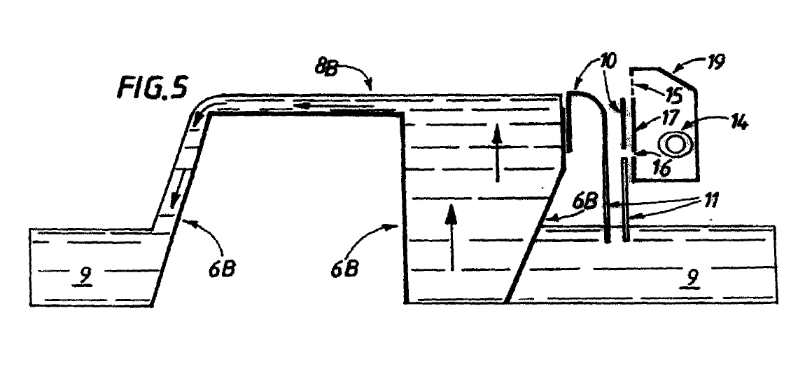

FIG. 4 is a schematic representation of a laminar wave in the soldering situation (with the solder flow partially reversed, i.e. some of the solder flows toward the downstream end by spilling over into the chute 10);

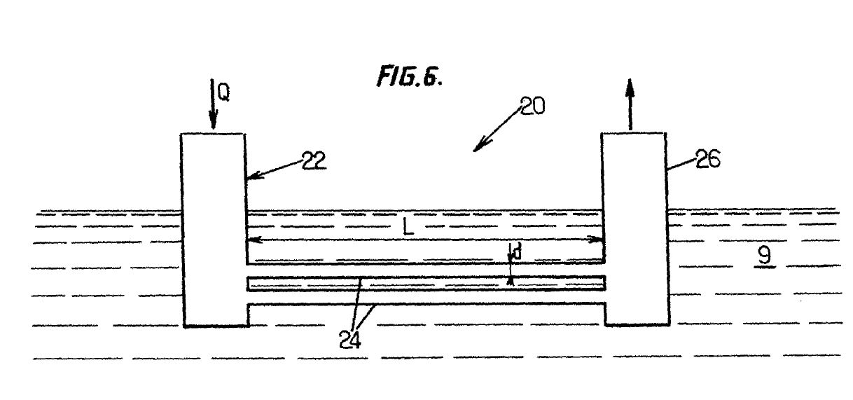

FIG. 5 is a partial schematic representation of a machine according to the invention; and

FIG. 6 is a schematic view of a gas feed device according to the invention.

For the sake of clarity, the various elements shown in the figures have not necessarily been shown to scale.

In the context of the invention, the term “gas” is understood to mean any type of gas, whether it be inert, such as nitrogen, irrespective of its method of production and its purity, or whether it be an active gas such as, for example, inert gas/reducing gas mixtures.

The wave soldering machine depicted schematically in FIG. 1 comprises three zones: a fluxing zone I, in which the parts 1 are fluxed by a fluxing system 3, for example of the spray type; a preheating zone II, in which the fluxed parts are preheated by the means 4, consisting for example of infrared lamps; and an actual soldering zone III, in which the parts 1 encounter here a single solder wave 8 obtained by pumping 7 of the solder bath 9 through a solder nozzle 6.

The cards 1 are conveyed along the various zones of the machine by means of a conveying system 2 consisting, for example, of a “finger” chain conveyor.

FIG. 2 provides a partial schematic sectional view of a case in which the solder bath 9 forms a two-wave structure, a turbulent first wave 8A of relatively abrupt structure obtained thanks to the structure of the nozzle 6A, and a laminar second wave 8B, offering a flat upper surface of relatively large extent, obtained thanks to the structure of the nozzle 6B. This figure shows several examples of gas injection means 19 close to one or other of the waves 8A, 8B.

FIGS. 3 and 4 illustrate the flow of the laminar solder wave 8B in a situation awaiting parts and in a situation for soldering a card 1, respectively, in the case for example of a machine provided with an overflow plate or chute.

FIG. 3 illustrates a situation awaiting a part, with the solder flowing toward the upstream end of the machine. The machine shown here includes the use of a weir system 10, taking the form of a guiding chute, located just downstream of the wave, and making it possible, by adjusting its height, to regulate the rate of overflow of the solder toward the downstream end, in this case here there being no or virtually no downstream flow.

FIG. 4 illustrates the downstream partial overflow effect. The arrival of the part 1 on the laminar wave causes the flow of the liquid solder to be partially reversed, making it flow toward the downstream end of the machine, i.e. toward the front, the forward overflow rate being regulated by adjusting the height of the chute system 10. The use of such a chute instead of a simple plate attached to the nozzle 6B also allows better guiding and return of the solder overflow into the bath 9.

FIG. 5 illustrates, partially and schematically, one embodiment of a wave soldering or tinning machine according to the invention, the representation being partial as it is centered on the laminar wave/injector/chute/skirt arrangement.

The wave shown in this figure is in the position awaiting parts, with flow toward the upstream end.

FIG. 5 therefore shows the presence of a submerged skirt 11, fastened to the chute system 10, and, positioned facing the skirt and the chute system, a gas injector 19 having a face or wall 17 that includes two groups of orifices 15 and 16.

As will be understood, it has been chosen in this FIG. 5 to represent the chute and the skirt, which is attached to said chute, by two different lines so as to make the figure easier to understand. Depending on the machines, the skirt and the chute need not be two separate parts joined together. It is also possible to use, right from the outset, a submerged chute.

The groups of orifices 15 and 16 are respectively positioned so as to be able to direct a first gas jet onto the flat surface of the laminar wave 8B and a second gas jet into the submerged skirt 11. The presence of the submerged skirt and of the second gas jet inside the skirt is most particularly effective for preventing any air entrainment effects on the flat surface of the laminar wave.

It will be noted that inside the injector 19 there is a porous tube 14, fed from an injection duct of a gas feed device according to the invention, said tube distributing this gas inside the expansion chamber that the body of the injector 19 constitutes.

FIG. 6 is a schematic representation of a gas feed device according to the invention.

The gas feed device 20 shown in FIG. 6 comprises a gas inlet duct 22, a set of two secondary ducts 24 submerged in the solder bath 9 of the soldering or tinning machine (at a chosen suitable point in the machine, taking into account the geometry of the machine in question and therefore the available space therein) and an injection duct 26 feeding at least one gas injector, such as the injector 14 shown in FIG. 5, or else one or more injectors 19/14 shown in FIG. 2.

The two secondary ducts 24 have their inlet ends connected to the inlet duct 22 and their outlet ends connected to the injection duct 26.

The inside diameter d of the secondary ducts and the gas flow rate Q₀ in the inlet duct are chosen so that the flow of the gas inside the secondary ducts is in a turbulent state (and satisfying the above-mentioned Reynolds relationship).

The inventors have observed that the gas temperature at the outset of the gas feed device according to the invention depends on parameters such as the state of flow of the gas in the duct, the gas flow rate Q₀ in the inlet duct, the diameter of the secondary ducts or else the submerged length of the secondary ducts.

In practice, the gas flow rate Q₀ in the inlet duct 22 is advantageously equal to or greater than 1 Nm³·h⁻¹, preferably greater than or equal to 5 Nm³·h⁻¹ and/or less than or equal to 15 Nm³·h⁻¹, preferably less than or equal to 10 Nm³·h⁻¹.

Surprisingly, the inventors have observed that the heat exchange is optimized when the flow of the gas in the secondary ducts is in a turbulent state (whereas it might have been expected, on the contrary, for it to be preferable to adopt a very low speed in the duct, so as to extend the heat exchange).

To avoid excessive noise and excessive pressure drop, the abovementioned speed relationship is preferably respected.

In practice, given the gas flow rates in the gas inlet duct and the geometry of the wave soldering machine, the inside diameters of the secondary ducts are preferably less than or equal to 10 mm.

The secondary ducts submerged in the solder bath are preferably made of inert materials, for example made of titanium or stainless steel.

Advantageously, through the choice of materials it is possible, on the one hand, to achieve better heat exchange and, on the other hand, a longer life of the secondary ducts, especially in the case of lead-free alloys that are corrosive.

The inventors have observed that by injecting nitrogen into the device as shown in FIG. 6 with an inside diameter d of the two secondary ducts of about 4 mm, a gas flow rate Q₀ in the inlet duct of about 5 m³/h and a length of the secondary ducts of about 1.1 m, the temperature of the nitrogen in the injection duct is about 99% of the temperature of the solder bath.

Advantageously, the wider the range of possible values for the gas flow rate Q₀ in the inlet duct, the more the performance of the wave soldering machine is independent of the stability of the gas flow in the inlet duct (in other words, for a given flow rate Q₀, several pairs (N,d) are possible—it is therefore advantageous to choose the pair that has the widest range of flow rates satisfying the Reynolds and speed relationships).

The present invention also relates to a method of designing a feed device according to the invention, comprising the following successive steps:
the estimation of the flow rate Q₀ in Nm³·s⁻¹ necessary for feeding gas to the inlet duct 22;
the determination of the pair or pairs (N,d) enabling a turbulent flow in the secondary ducts 24 and for meeting said “speed limit” relationship; and
the choice of a triplet (N,d,L) as a function of the geometry of the wave soldering or tinning machine on which the gas feed device is intended to be installed.

For each pair (N,d), the length L of the secondary ducts is determined so that L/d≧100 and preferably L/d≦275.

1-10. (canceled)

11. A gas feed device for a wave soldering or tinning machine, said machine being capable of generating at least one solder wave, said gas feed device comprising:
a gas inlet duct;
an injection duct feeding at least one gas injector with gas close to said at least one wave; and
a set of N secondary ducts adapted to be submerged in the solder bath of the soldering or tinning machine, each secondary duct having its inlet end connected to the inlet duct and its outlet end connected to the injection duct, the number N of secondary ducts is equal to or greater than 1, an inside diameter d of the secondary ducts and a gas flow rate Q₀ in the inlet duct are chosen such that the flow of the gas inside the secondary ducts is in a turbulent state.

12. The device of claim 11, wherein the number N of secondary ducts, the gas flow rate Q₀ in the inlet duct in Nm³·s⁻¹, and the inside diameter d in meters of the secondary ducts satisfy the Reynolds relationship at the secondary duct outlet of:
(4ρ₀Q₀)/(μₛπNd)≧2500,
where ρ₀ is the density of the gas in kg·m⁻³ (normalized to a temperature of 0° C. and a pressure of 1013 mbar) and μₛ is the dynamic viscosity of the gas in Pa·s at the outlet of each secondary duct.

13. The device of claim 11, wherein the following speed limit relationship is satisfied:
Q₀≦(ρₛπd²N170)/(4ρ₀),
in which ρₛ is the density of the gas in kg·m⁻³ at the submerged duct outlet.

14. The device of claim 11, wherein L/d≧100, where L is the length in meters of the N secondary ducts and d is the inside diameter of the N secondary ducts in meters.

15. The device of claim 11, wherein L/d≦275, where L is the length in meters of the N secondary ducts and d is the inside diameter of the N secondary ducts in meters.

16. The device of claim 11, wherein the secondary ducts have an inside diameter d of 10 mm or less.

17. The device of claim 11, wherein the gas flow rate Q₀ in the inlet duct is less than or equal to 15 Nm³·h⁻¹ and/or greater than or equal to 1 Nm³·h⁻¹.

18. The device of claim 12, wherein (4ρ₀Q₀)/(μₛπNd)≧4000.

19. The device of claim 13, wherein Q₀≦(ρₛπd²N200)/(4ρ₀).

20. A wave soldering or tinning machine comprising the device of claim 11.

21. A method of designing the device of claim 11, comprising the following successive steps:
estimating the flow rate Q₀ in Nm³·s⁻¹ necessary for feeding gas to the inlet duct;
determining values for N and d that enabling a turbulent flow in the secondary ducts and that satisfy the speed limit relationship of Q₀≦(ρₛπd²N170)/(4ρ₀) in which ρₛ is the density of the gas in kg·m⁻³ at the submerged duct outlet;
determining values for the length L of the N secondary ducts that satisfy a length equation of 100≦L/d≦275; and
selecting values for N, d, and L as a function of the geometry of the wave soldering or tinning machine on which the gas feed device is intended to be installed.

22. A wave soldering or tinning process, comprising the steps of:
providing the gas feed device of claim 11; and
bringing a part to be soldered or tinned into contact with at least one liquid solder wave in which a gas is directed onto at least one portion of the wave by the gas injector.
